(19) United States
(12) Patent Application Publication
(10) Pub. No.: US 2011/0205334 A1
(43) Pub. Date: Aug. 25, 2011

(54) DISPLAY DEVICE AND IMAGE VIEWING SYSTEM

(76) Inventors: Shuji INOUE, Okayama (JP); Kazuo Okamoto, Osaka (JP); Seiji Nakazawa, Osaka (JP)

(21) Appl. No.: 12/971,712

(22) Filed: Dec. 17, 2010

(30) Foreign Application Priority Data
Dec. 18, 2009 (JP) 2009-287120

(51) Int. Cl. H04N 13/00

(52) U.S. Cl. 348/43; 348/E13.001

(57) ABSTRACT

A display device for displaying a stereoscopic image including a left-eye image viewed by a left eye and a right-eye image viewed by a right eye including: a display portion configured to display the left-eye image and the right-eye image; and a transmitter configured to transmit a synchronization signal synchronized with the stereoscopic image, wherein the transmitter includes a first transmitter and a second transmitter disposed away from the first transmitter.

### RELATED APPLICATION

This application claims priority based on Japanese Patent Application No. 2009-287120 (filing date: Dec. 18, 2009).

### BACKGROUND OF THE INVENTION

1. Field of the Invention

The present invention relates to a display device for displaying images and an image viewing system for allowing a viewer to view the images. More specifically, the present invention relates to a display device for providing images stereoscopically perceived by switching a left-eye image viewed by the left eye and a right-eye image viewed by the right eye with outputting synchronization signals synchronized with the switching operation between the left-eye image and the right-eye image. The present invention also particularly relates to an image viewing system including the display device.

2. Description of the Background Art

Various image viewing systems for providing viewers with stereoscopically perceived images have been developed. A typical image viewing system comprises a display device configured to display a left-eye image viewed by the left eye (to be referred to as “L image” hereinafter) and a right-eye image viewed by the right eye (to be referred to as “R image” hereinafter) by temporally switching these images and a spectacle device configured to open/close a left shutter in front of the left eye and a right shutter in front of the right eye in synchronization with the switching operation between the L image and the R image. The opening/closing operation of the left and right shutters allows a viewer wearing the spectacle device to view the L image with the viewer's left eye alone and the R image with the viewer's right eye alone. As a result, the viewer stereoscopically perceives a series of images displayed by the display device.

The image viewing system performs synchronous control for synchronizing the display device and the spectacle device to allow the viewer to view the L image with the viewer's left eye and the R image with the viewer's right eye. The display device typically transmits, to the spectacle device, synchronization signals synchronized with the display of the images, and the spectacle device then receives the synchronization signals.

Japanese Patent Application Publication No. H6-178325 discloses a transmission device configured to transmit synchronization signals. According to the disclosure, the transmission device is mounted on the display device.

Display devices with wider display screens become more popular in recent years. Such display devices allow viewers to view wider images.

When the display device displays wider images, even the viewers far from the display device may enjoy the images. When those viewers far from the display device view the images, the synchronization signals mentioned above may not reach the spectacle devices worn by the viewers. For instance, the farther the viewers are from the display device, the more obstacles interfering with communication of the synchronization signals potentially increases.

### SUMMARY OF THE INVENTION

The present invention aims to provide a display device and an image viewing system configured to achieve more reliable communication of synchronization signals to allow viewers to view excellent stereoscopic images.

A display device for displaying a stereoscopic image including a left-eye image viewed by a left eye and a right-eye image viewed by a right eye according to one aspect of the present invention includes: a display portion configured to display the left-eye image and the right-eye image; and a transmitter configured to transmit a synchronization signal synchronized with the stereoscopic image, wherein the transmitter includes a first transmitter and a second transmitter disposed away from the first transmitter.

An image viewing system according to another aspect of the present invention includes a display device configured to display a stereoscopic image including a left-eye image viewed by a left eye and a right-eye image viewed by a right eye, and a spectacle device configured to perform auxiliary operation to assist in viewing the stereoscopic image so as to allow the left eye to view the left-eye image and the right eye to view the right-eye image, wherein the display device includes a display portion configured to display the left-eye image and the right-eye image, and a transmitter configured to transmit a synchronization signal synchronized with the stereoscopic image, the spectacle device executes the auxiliary operation based on the synchronization signal, and the transmitter includes a first transmitter and a second transmitter disposed away from the first transmitter.

### BRIEF DESCRIPTION OF THE DRAWINGS

FIG. 1 is a schematic diagram showing an image viewing system according to a first embodiment;

FIG. 2 is a schematic perspective top view of an image viewing system with a single transmitter;

FIG. 3 is a schematic perspective top view of the image viewing system shown in FIG. 1;

FIG. 4A is a perspective view showing a light emitter used as a transmitter of the image viewing system shown in FIG. 1;

FIG. 4B is a perspective view showing a light emitter used as the transmitter of the image viewing system shown in FIG. 1;

FIG. 5A is a graph schematically showing emittance characteristics of the light emitter shown in FIG. 4A;

FIG. 5B is a graph schematically showing emittance characteristics of the light emitter shown in FIG. 4B;

FIG. 6 is a schematic perspective top view of an image viewing system with a single transmitter;

FIG. 7 is a schematic perspective view of an emission module used as the transmitter of the image viewing system shown in FIG. 1;

FIG. 8 is a schematic perspective top view of the image viewing system shown in FIG. 1;

FIG. 9 is a schematic perspective view of an emission module used as the transmitter of the image viewing system shown in FIG. 1;

FIG. 10 is a schematic perspective top view of the image viewing system shown in FIG. 1;

FIG. 11 is a schematic diagram showing an image viewing system according to a second embodiment;

FIG. 12 is a schematic diagram showing a display device according to a third embodiment;

FIG. 13 is a schematic diagram showing the image viewing system according to the second embodiment;

FIG. 14 is a schematic diagram showing an image viewing system according to the third embodiment;

FIG. 15 is a schematic diagram showing a display device according to a fourth embodiment; and

FIG. 16 is a schematic diagram showing an image viewing system according to a fifth embodiment.

### DETAILED DESCRIPTION OF THE PREFERRED EMBODIMENTS OF THE INVENTION

A display device and image viewing system according to the embodiments of the present invention are described hereinafter with reference to the accompanying diagrams. In the following descriptions of the embodiments, the same reference numerals are used on the same components. In addition, if necessary, repetitive descriptions are omitted for the sake of brevity. In the diagrams, the configurations, placements, or shapes as well as the descriptions associated with the diagrams aim to provide easy understanding of the principles of the embodiments and not to limit the scope of the present invention in any way.

### First Embodiment

(Configuration of Image Viewing System)

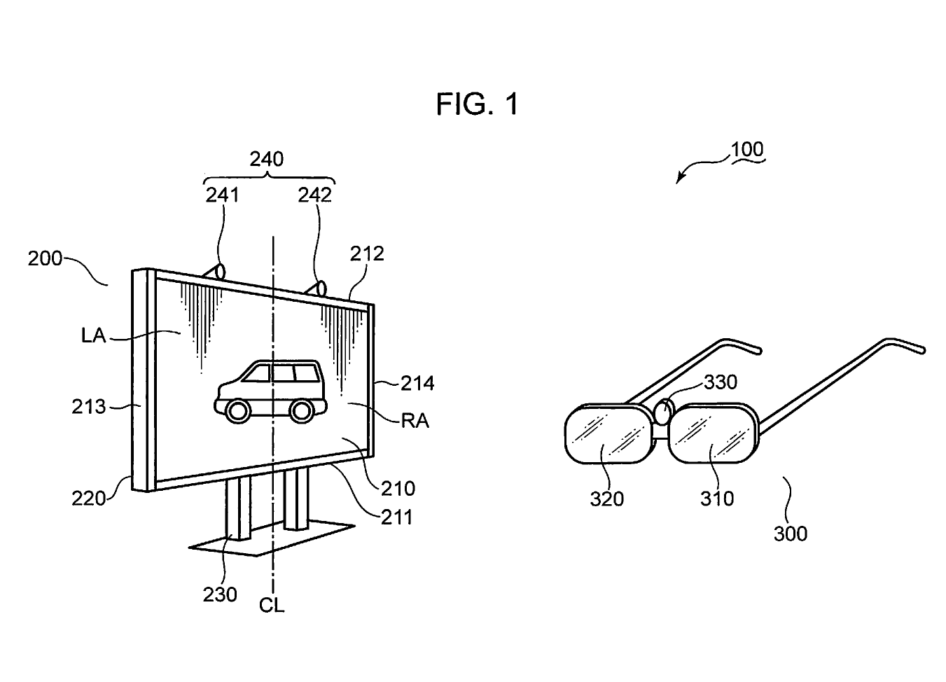

FIG. 1 is a schematic diagram showing an image viewing system according to a first embodiment. A schematic configuration of the image viewing system is described with FIG. 1.

An image viewing system 100 comprises a display device 200 configured to display a stereoscopic image including a left-eye image created to be viewed with a left eye (to be referred to as “L image” hereinafter) and a right-eye image created to be viewed with a right eye (to be referred to as “R image” hereinafter), and a spectacle device 300 configured to perform auxiliary operation to assist in viewing the stereoscopic images. A viewer wears the spectacle device 300 to view the L image and the R image which are temporarily alternately displayed by the display device 200 and to stereoscopically perceive the images displayed by the display device 200.

(Configuration of Display Device)

The display device 200 comprises a substantially rectangular display portion 210 configured to alternately display the L image and the R image, a frame 220 configured to surround the display portion 210, a base 230 configured to support the frame 220 and the display portion 210, and a transmitter 240 configured to transmit synchronization signals to the spectacle device 300.

The display device 200 displays images on the display portion 210. In the present embodiment the L image and the R image are temporally alternately switched and displayed on the display portion 210. The L image and the R image may be switched every certain number of frames.

As described hereinafter, stereoscopic images are displayed on the display portion 210. In addition to the stereoscopic images, two-dimensional images may be optionally displayed on the display portion 210.

The frame 220 includes a lower frame portion 211 extending along a lower edge of the substantially rectangular display portion 210, an upper frame portion 212 extending along an upper edge of the display portion 210, a left frame portion 213 extending along a left edge of the display portion 210, and a right frame portion 214 extending along a right edge of the display portion 210. The frame 220 may be used as a part of the housing for protecting and supporting the display portion 210.

The base 230 supports the display portion 210 supported and protected by the frame 220. It should be noted that the display device may not include the base if the display portion is directly hanged to a wall of a room.

FIG. 1 shows a centerline CL, which is defined so as to evenly divide the display portion 210 into a left area LA and a right area RA. The transmitter 240 includes a left transmitter 241 disposed on the left side with respect to the centerline CL and a right transmitter 242 disposed on the right side with respect to the centerline CL. The right transmitter 242 is apart from the left transmitter 241 by a predetermined distance. It should be noted that the distance between the left transmitter 241 and the right transmitter 242 is appropriately defined according to characteristics of these transmitters (e.g., magnitudes or shapes of transmitting ranges of the synchronization signals from the left transmitter 241/right transmitter 242). The left transmitter 241 and the right transmitter 242 are preferably disposed substantially symmetrically with respect to the centerline CL. In the present embodiment, the left transmitter 241 is exemplified as one of the first transmitter and the second transmitter while the right transmitter 242 is exemplified as the other.

The synchronization signals are transmitted toward the spectacle device 300 from the left transmitter 241 and the right transmitter 242 which are fixed onto the upper frame portion 212. The transmitter 240 transmits the synchronization signals in synchronization with the display of the stereoscopic images. For example, the transmitter 240 transmits the synchronization signals in accordance with the timing when the display of the L image and the R image starts. The display device 200 may generate and output the synchronization signals using any known methods. In the present embodiment the transmitter 240 transmits infrared signals as the synchronization signals. The transmitter may also transmit, as the synchronization signals, other types of signals to communicate with the spectacle device. In the present embodiment, the synchronization signals, which are output from the transmitter 240, are used for performing synchronous control between the display device 200 and the spectacle device 300. In addition, the synchronization signals output from the transmitter may be used for performing synchronous control between other devices than the spectacle device and the display device.

(Configuration of Spectacle Device)

The spectacle device 300, which substantially looks like a typical vision correction glasses, comprises a left shutter 310 in front of the viewer's left eye, a right shutter 320 in front of the viewer's right eye, and a receiver 330 configured to receive the synchronization signals transmitted from the transmitter 240.

The left shutter 310 opening when the L image is displayed on the display portion 210 increases an incident light amount of the L image into the left eye of the viewer wearing the spectacle device 300. The left shutter 310 closing when the R image is displayed on the display portion 210 decreases the incident light amount into the left eye of the viewer wearing the spectacle device 300. In the present embodiment, a shutter element is used as an optical element to increase/decrease the incident light amount into the left eye. Alternatively, an optical element configured to deflect the light propagating toward the left eye or another type of optical element configured to adjusts or changes characteristics of the incident light into the left eye may be used instead of the left shutter 310.

The right shutter 320 opening when the R image is displayed on the display portion 210 increases an incident light amount of the R image into the right eye of the viewer wearing the spectacle device 300. The right shutter 320 closing when the L image is displayed on the display portion 210 decreases the incident light amount of the L image into the right eye of the viewer wearing the spectacle device 300. In the present embodiment, a shutter element is used as an optical element to increase/decrease the incident light amount into the right eye. Alternatively, an optical element configured to deflect the light propagating toward the right eye or another type of optical element configured to adjust or change characteristics of the incident light into the right eye may be used instead of the right shutter 320.

The receiver 330 between the left shutter 310 and the right shutter 320 receives the synchronization signals transmitted from the transmitter 240 of the display device 200. The opening and closing operation of the abovementioned left shutter 310 and right shutter 320 is controlled on the basis of the synchronization signals received by the receiver 330. As a result of receiving the synchronization signals, the spectacle device 300 executes auxiliary operation for allowing the viewer to view the L image with the viewer's left eye and the R image with the viewer's right eye. The spectacle device 300 may process the synchronization signals using any known methods to carry out the auxiliary operation.

(Operations of Image Viewing System)

The image viewing system 100 allows the viewer to view the stereoscopic images under the synchronous control between the display device 200 and the spectacle device 300. On the display portion 210 of the display device 200, the L image and the R image are alternately displayed at a frame rate of, for example, 120 Hz, or displayed by switching the L image and the R image at certain intervals. The transmitter 240 transmits the synchronization signals to the spectacle device 300 in synchronization with the switching operation between the L image and the R image displayed on the display portion 210.

The receiver 330 of the spectacle device 300 receives the synchronization signals transmitted from the transmitter 240 of the display device 200. Once the spectacle device 300 receives the synchronization signals, the left shutter 310 and the right shutter 320 are controlled on the basis of the received synchronization signals. The left shutter 310 and the right shutter 320 are opened/closed as described above, to adjust the incident light amount (or the characteristics of the light) into the left eye and the right eye of the viewer.

For instance, when the display portion 210 switches from the R image to the L image, the transmitter 240 of the display device 200 transmits the synchronization signals, which indicate that the L image is displayed on the display portion 210. The spectacle device 300 after the reception of the synchronization signals opens the left shutter 310 and closes the right shutter 320. Therefore, the incident light amount into the left eye of the viewer increases whereas the incident light amount into the right eye decreases. As a result, the viewer views the L image on the display portion 210 with the left eye but not with the right eye.

When, for example, the display portion 210 switches from the L image to the R image, the transmitter 240 of the display device 200 transmits the synchronization signals, which indicate that the R image is displayed on the display portion 210. The spectacle device 300 after the reception of the synchronization signals opens the right shutter 320 and closes the left shutter 310. Therefore, the incident light amount into the right eye of the viewer increases whereas the incident light amount into the left eye decreases. As a result, the viewer views the R image on the display portion 210 with the right eye but not with the left eye.

In the present embodiment, the L image and the R image which are displayed on the display portion 210 expresses contents differentiated by parallax of viewers (for example, a common object between the L image and the R image is rendered in different positions by the parallax of the viewers). In this case, the viewer perceives the parallax in the images displayed on the display portion 210. As a result, the viewer stereoscopically perceives the images displayed on the display portion 210, even when the display portion 210 is a substantially flat display screen of the display device. For example, the viewer perceives the object displayed in the images, as if the object actually jumps out or retracts from or to a flat display screen of the display portion 210.

(Transmitting Range)

It may be the most important to synchronize the left shutter 310/the right shutter 320 with the switching operation of the images displayed by the display device 200 (the switching display operation between the L image and the R image) in order for the above-described image viewing system 100 to provide the viewer with stereoscopic images. Thus, it is preferable that communication reliability of the synchronization signals between the display device 200 and the spectacle device 300 is improved as much as possible.

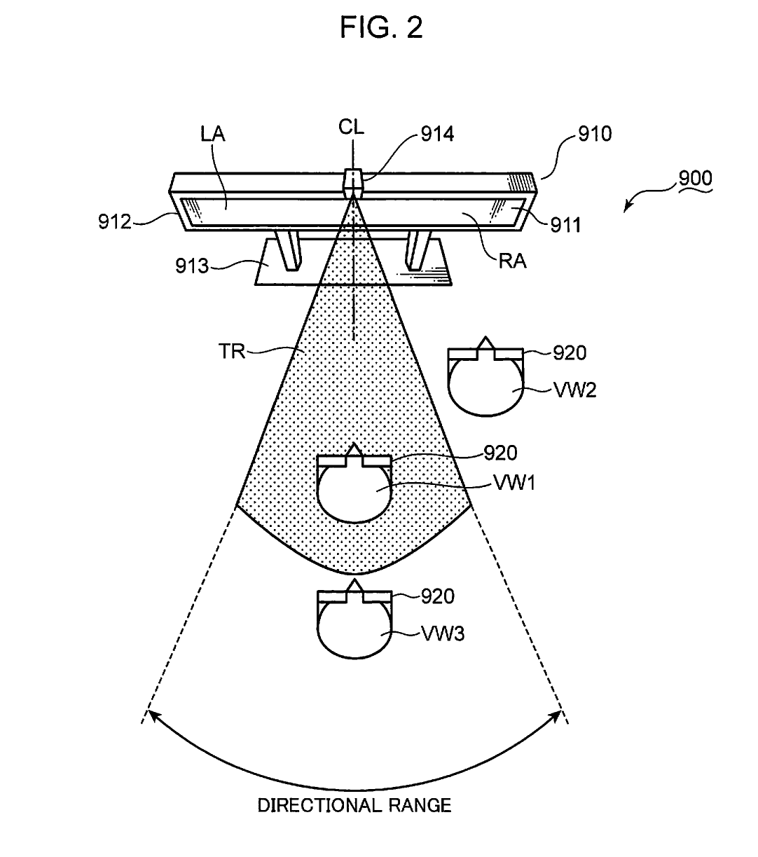

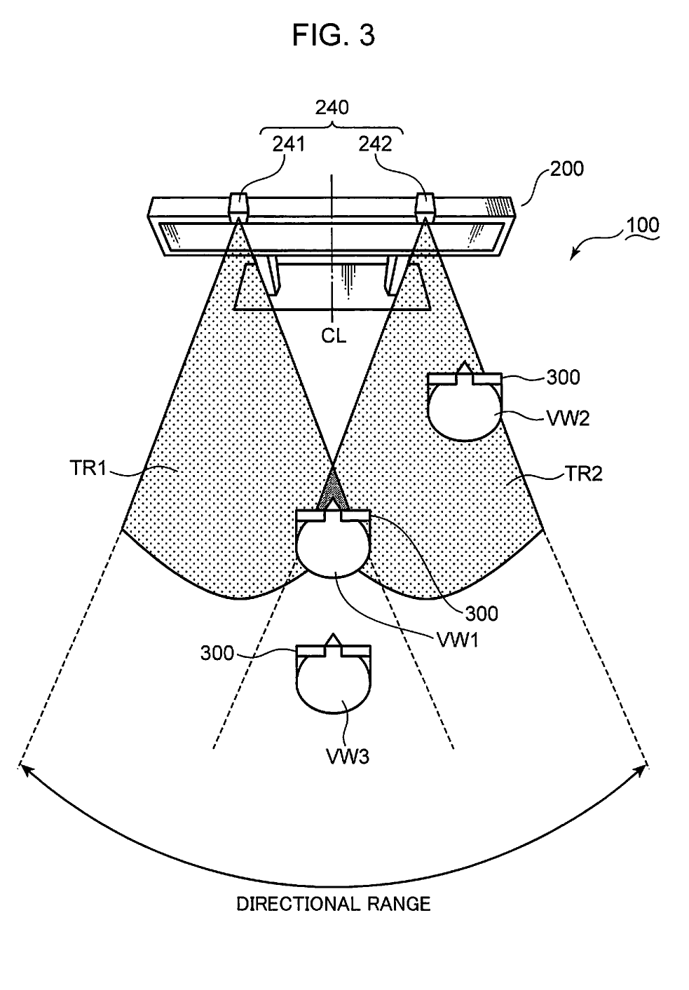

FIG. 2 is a schematic perspective top view of an image viewing system with a single transmitter. FIG. 3 is a schematic perspective top view of the image viewing system 100 according to the present embodiment. FIGS. 2 and 3 are used for describing advantages of the synchronization signal communication in the image viewing system 100 according to the present embodiment.

An image viewing system 900 shown in FIG. 2 comprises a display device 910 and a spectacle device 920. FIG. 2 shows three viewers VW1, VW2 and VW3, who wear the spectacle devices 920, respectively.

The display device 910 comprises a substantially rectangular display portion 911 configured to alternately display the L image and the R image, a frame 912 configured to surround the display portion 911, a base 913 configured to support the frame 912 and display portion 911, and one transmitter 914 configured to transmit the synchronization signals.

FIG. 2 shows a centerline CL, which is defined so as to evenly divide the display portion 911 into a left area LA and a right area RA. The transmitter 914 fixed onto the frame 912 is on the vertically extending centerline CL.

A substantially fan-shaped hatching area shown in FIG. 2 represents a transmitting range TR of the synchronization signals transmitted from the transmitter 914. The transmitting range TR radially spreads out from the transmitter 914.

As shown in FIG. 2, the viewer VW1 exists within the transmitting range TR. This means that the spectacle device 920 worn by the viewer VW1 may appropriately receive the synchronization signals transmitted from the transmitter 914. As a result, the viewer VW1 may suitably view stereoscopic images displayed on the display portion 911.

The viewer VW2 exists in a position outside the transmitting range TR. The spectacle device 920 of the viewer VW2 who stands on the right side with respect to and outside the transmitting range TR, which is defined according to directional characteristics of the transmitter 914 configured to output the synchronization signals (infrared rays). Thus, it is less like that the spectacle device 920 properly receives the synchronization signals transmitted by the display device 910. The viewer VW2, therefore, may not appropriately view stereoscopic images displayed by the display portion 911.

The viewer VW3 exists within a directional range defined by the directional characteristics of the transmitter 914 configured to output the synchronization signals (infrared rays). However, the viewer VW3 exists too far from the transmitter 914, and hence stays outside the transmitting range TR. As a result, it is likely that the spectacle device 920 of the viewer VW3 receives weaker signals. Therefore, the viewer VW3 may not appropriately view stereoscopic images displayed by the display portion 911.

The problems of the image viewing system 900 shown in FIG. 2 include, in addition to the narrower transmitting range TR described above, obstacles which may block the synchronization signals. For instance, it is likely that communication of the synchronization signals are blocked if someone walks between the transmitter 914 and the viewer VW1.

As shown in FIG. 3, the image viewing system 100 according to the present embodiment comprises the display device 200 including the left transmitter 241 and the right transmitter 242. FIG. 3 shows two hatching areas in substantial fan shape. The hatching area radially spreading out from the left transmitter 241 means a transmitting range TR1 of the synchronization signals transmitted from the left transmitter 241. The hatching area radially spreading out from the right transmitter 242 means a transmitting range TR2 of the synchronization signals transmitted from the right transmitter 242.

In the present embodiment, the left transmitter 241 and the right transmitter 242 are disposed on the left side and the right side with respect to the centerline CL, respectively. Thus, the transmitting ranges (the transmitting ranges TR1 and TR2) of the synchronization signals transmitted from the transmitter 240 are wider than the transmitting range TR spreading out from the transmitter 914 shown in FIG. 2. In the present embodiment, horizontal restriction in the transmission range, which results from the directional characteristics of the left transmitter 241 and the right transmitter 242, may be moderated because the left transmitter 241 and the right transmitter 242 are disposed on the left side and the right side with respect to the centerline CL, respectively.

FIG. 3 shows the viewers VW1, VW2 and VW3, as with FIG. 2. The viewers VW1, VW2 and VW3 in FIG. 3 stand at the same positions as the viewers VW1, VW2 and VW3 shown in FIG. 2.

As described in the context of FIG. 2, the viewer VW2 may not appropriately view the stereoscopic images displayed by the display device 910. However, the viewer VW2 shown in FIG. 3 exists within the transmitting range TR2 because the left transmitter 241 and the right transmitter 242 moderate the horizontal restriction on the transmission ranges as described above. Thus, the spectacle device 300 of the viewer VW2 may appropriately receive the synchronization signals from the right transmitter 242. Therefore, the transmitting ranges (transmitting ranges TR1 and TR2) of the synchronization signals are properly widened by the transmitters (the left transmitter 241 and the right transmitter 242).

As shown in FIG. 3, the viewer VW1 exists in an overlapping area between the transmitting ranges TR1 and TR2. Therefore, even if someone walks between one of the left transmitter 241 and the right transmitter 242 and the viewer VW1, the spectacle device 300 of the viewer VW1 may receive the synchronization signals transmitted from the other of the left transmitter 241 and the right transmitter 242. The spectacle device 300 of the viewer VW1 may therefore appropriately continue to perform the auxiliary operation for assisting in viewing the stereoscopic images. In the present embodiment, the left transmitter 241 and the right transmitter 242 are used for transmitting the synchronization signals. Alternately, two or more of the transmitters may be used for the transmission of the synchronization signals.

(Transmitters)

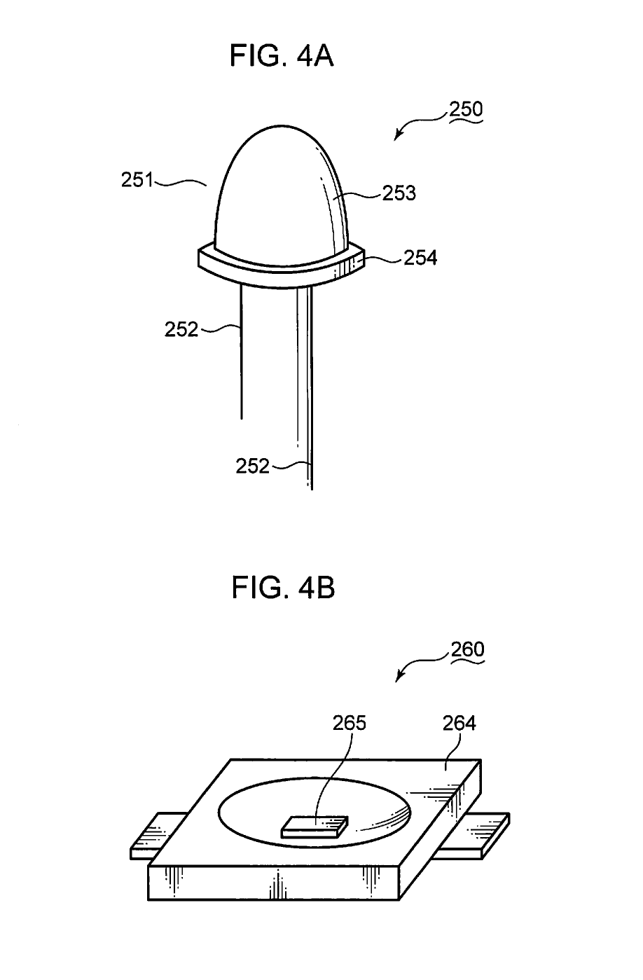

FIGS. 4A and 4B are schematic perspective views of light emitters used as the left transmitter 241 and the right transmitter 242. The transmitter 240 is described with FIGS. 4A and 4B.

The light emitters are generally classified into the type shown in FIG. 4A and the type shown in FIG. 4B. The light emitters shown in FIGS. 4A and 4B both emit infrared rays.

A light emitter 250 shown in FIG. 4A comprises a main body 251 and a pair of terminals 252 extending from a bottom surface of the main body 251. The terminals 252 are inserted into through-holes defined on a circuit board (through-hole mount type). A light emitter 260 shown in FIG. 4B is directly mounted on a surface of a circuit board (surface mount type).

The main body 251 of the light emitter 250 shown in FIG. 4A includes a substantially bullet-shaped cover 253, an emitting portion (not shown) configured to emit an infrared ray, and a base 254 configured to support the cover 253 and the emitting portion which is covered with the cover 253.

The light emitter 260 shown in FIG. 4B includes a base 264 and an emitting portion 265 configured to emit an infrared ray. The emitting portion 265 fixed to the base 264, is exposed.

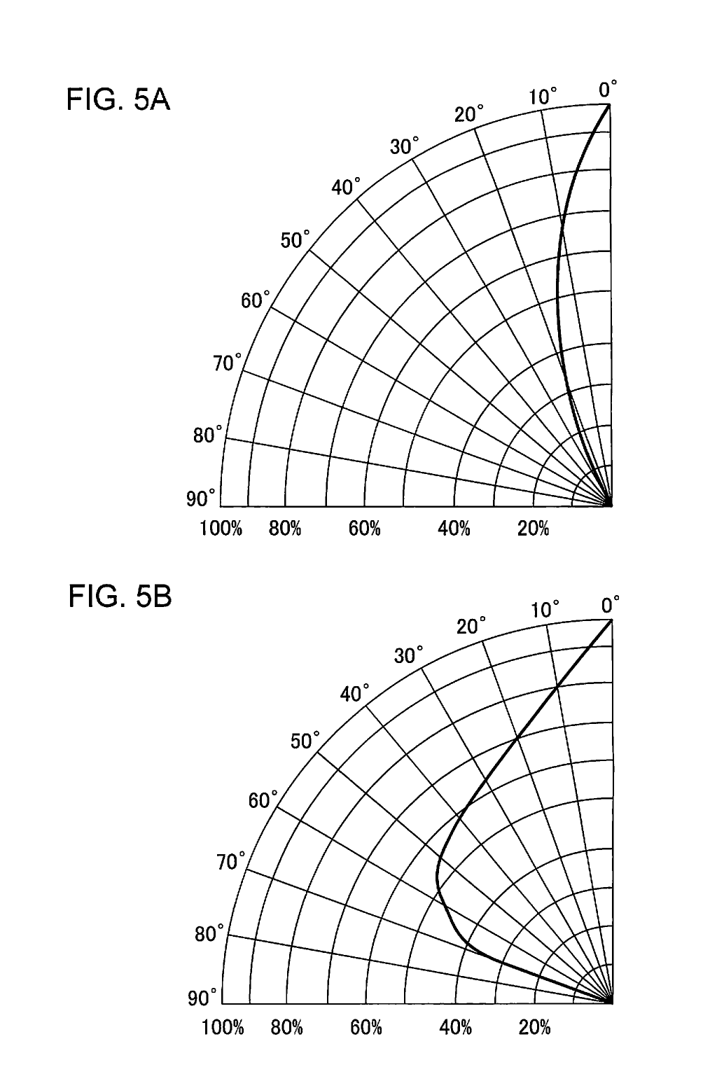

FIG. 5A is a graph illustrating the directional characteristics of the light emitter 250 shown in FIG. 4A. FIG. 5B is a graph showing the directional characteristics of the light emitter 260 shown in FIG. 4B. The directional characteristics of the light emitters 250, 260 are described with FIGS. 4A to 5B.

An emission direction of the light emitter 250 shown in FIG. 4A is deflected to one direction. This means that the light emitter 250 has narrower directional characteristics. The directional characteristics of the light emitter 250 are narrower whereas forward emittance of the infrared ray from the light emitter 250 is higher.

The infrared ray is directly emitted from the emitting portion 265 of the light emitter 260 shown in FIG. 4B. As a result, the forward emittance of the infrared right from the light emitter 260 is lower. On the other hand, the light emitter 260 has wider directional characteristics, as shown in FIG. 5B.

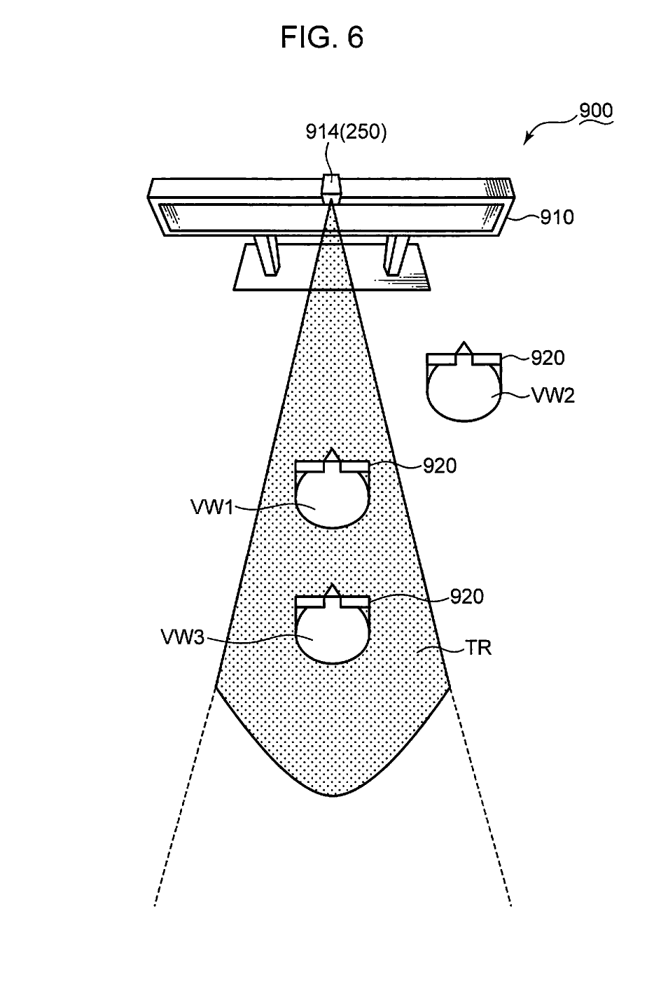

FIG. 6 is a schematic perspective top view of the image viewing system 900 using the light emitter 250. Adjustment of the transmitting ranges based on the directional characteristics of the light emitters is described with FIGS. 2, 4A, 5A and 6.

The light emitter 250 with narrower directional characteristics than those of the transmitter 914 shown in FIG. 2 is used as the transmitter 914 shown in FIG. 6. Therefore, a transmitting range TR shown in FIG. 6 is narrower than the transmitting range TR shown in FIG. 2 and extends far away from the transmitter 914.

FIG. 6 shows the viewers VW1, VW2 and VW3, as with FIG. 2. The viewers VW1, VW2 and VW3 in FIG. 6 stand at the same position as the viewers VW1, VW2 and VW3 shown in FIG. 2.

The viewer VW3 shown in FIG. 2 exists outside the transmitting range TR extending from the transmitter 914, so that the spectacle device 920 of the viewer VW3 therefore may not receive the synchronization signals. On the other hand, when the light emitter 250 is used as the transmitter 914, the transmitting range TR extends in a front direction and encompasses the viewer VW3 to allow the spectacle device 920 of the viewer VW3 to appropriately receive the synchronization signals.

The viewer VW3 exists farther from the display device 910 than the viewer VW1. As described above, because of the narrow directional characteristics and higher forward emittance of the light emitter 250 used as the transmitter 914, the viewer VW3 existing far away from the display device 910 may appropriately view the stereoscopic images displayed by the display device 910.

Generally, the larger the display portion (display screen) of the display device, the farther away the viewer is from the display device to view the images. According to the principles for adjusting the transmitting ranges based on the directional characteristics of the light emitters, the viewers may view the images displayed on a large display portion under the stable auxiliary operation performed by the spectacle device.

The principles for adjusting the transmitting ranges based on the directional characteristics of the light emitters may be similarly applied to the display device 200 of the present embodiment and the transmitter 240 of the image viewing system 100 (see FIGS. 1, 4A and 4B). The light emitter 250 with the narrower direction characteristics and higher forward emittance may be used as the left transmitter 241 and/or the right transmitter 242 to cause the synchronization signals to reach the spectacle device 300 of the viewer existing away from the display device 200. Alternatively, the light emitter 260 with the wider directional characteristics and lower forward emittance may be used as the left transmitter 241 and/or the right transmitter 242 to widen the transmitting range in the horizontal direction.

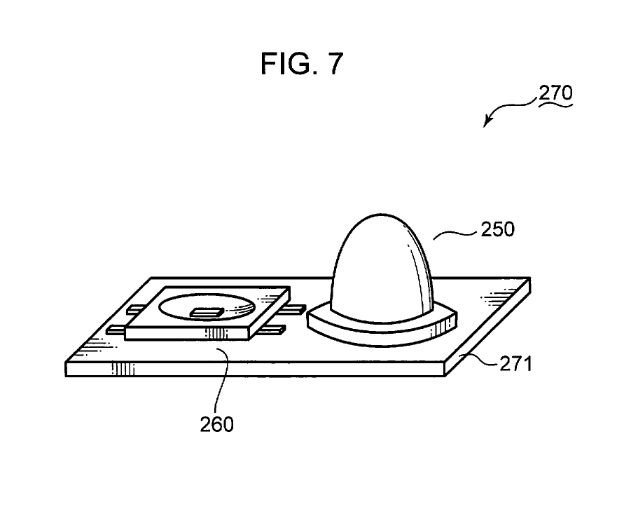

FIG. 7 is a schematic perspective view of an emission module used as the transmitter 240. The emission module is described with FIGS. 1, 4A to 5B, and 7.

An emission module 270 comprises a circuit board 271 in addition to the light emitters 250 and 260 described above. The light emitters 250 and 260 are mounted to the circuit board 271. In addition to the light emitters 250 and 260, the circuit board 271 includes a circuit connected to a power source or a control IC (not shown).

As described in the context of FIGS. 4A and 5A, the directional characteristics of the light emitter 250 are narrower. Also, as described in the context of FIGS. 4B and 5B, the directional characteristics of the light emitter 260 are wider.

As shown in FIG. 7, the emission module 270 comprises both the light emitter 250 with the narrower directional characteristics (higher forward emittance) and the light emitter 260 with the wider directional characteristics (lower forward emittance).

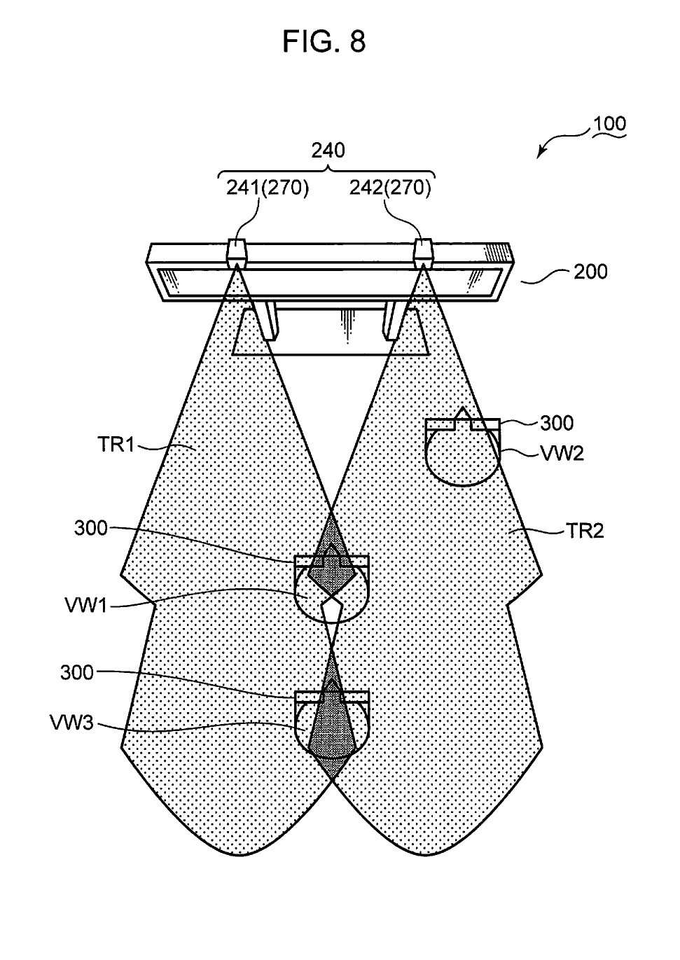

FIG. 8 is a perspective top view of the image viewing system 100 according to the present embodiment. The image viewing system 100 with the emission module 270 is described with FIGS. 3, 7 and 8.

The emission module 270 is used as the left transmitter 241 and the right transmitter 242 of the display device 200. As described above, the emission module 270 comprises both the light emitter 250 with the narrower directional characteristics (higher forward emittance) and the light emitter 260 with the wider directional characteristics (lower forward emittance). Therefore, the transmitting range TR1 from the left transmitter 241 and the transmitting range TR2 from the right transmitter 242 horizontally spread out near the display device 200. Furthermore, the transmitting ranges TR1 and TR2 extend longer in the front direction of the display device 200. In comparison with FIGS. 2 and 8, it is figured out that the transmitting ranges TR1, TR2 shown in FIG. 8 are wider than the transmitting range TR shown in FIG. 2, in the horizontal direction and in the front direction.

The positions of the viewers VW1, VW2 and VW3 shown in FIG. 8 are the same as the positions shown in FIG. 2. When the emission module 270 is used as the left transmitter 241 and the right transmitter 242, all the viewers VW1, VW2 and VW3 exist within the transmitting ranges TR1 and/or TR2. Thus, the spectacle devices 300 of the viewers VW1, VW2 and VW3 may appropriately receive the synchronization signals transmitted from the transmitter 240.

As described above, the emission module 270 used as the transmitter 240 may appropriately improve the narrow directional characteristics and the short transmission distance of the synchronization signals.

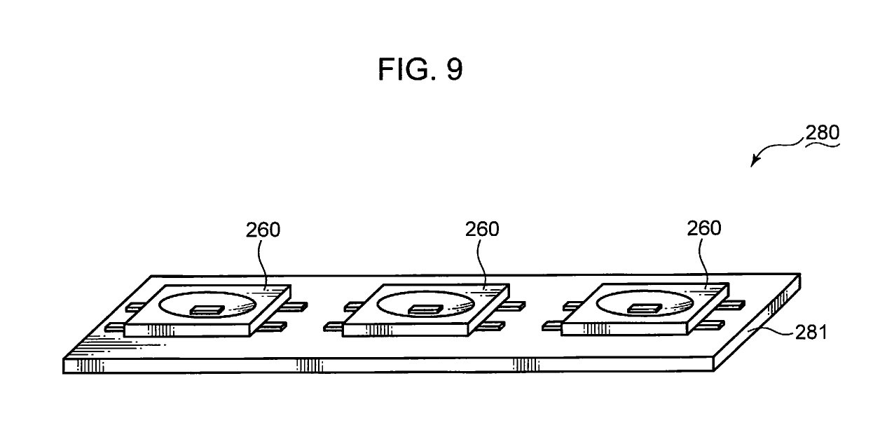

FIG. 9 is a schematic perspective view of another emission module which is used as the transmitter 240. The emission module is described with FIGS. 1, 4B, 5B and 9.

An emission module 280 comprises a circuit board 281 in addition to the abovementioned light emitter 260. The circuit board 281 is provided with three light emitters 260 which are sequentially aligned. In addition to these three light emitters 260, the circuit board 281 includes a circuit connected to a power source or a control IC (not shown).

As described in the context of FIGS. 4B and 5B, the directional characteristics of the three light emitters 260 are wider (the forward emittance is lower), respectively.

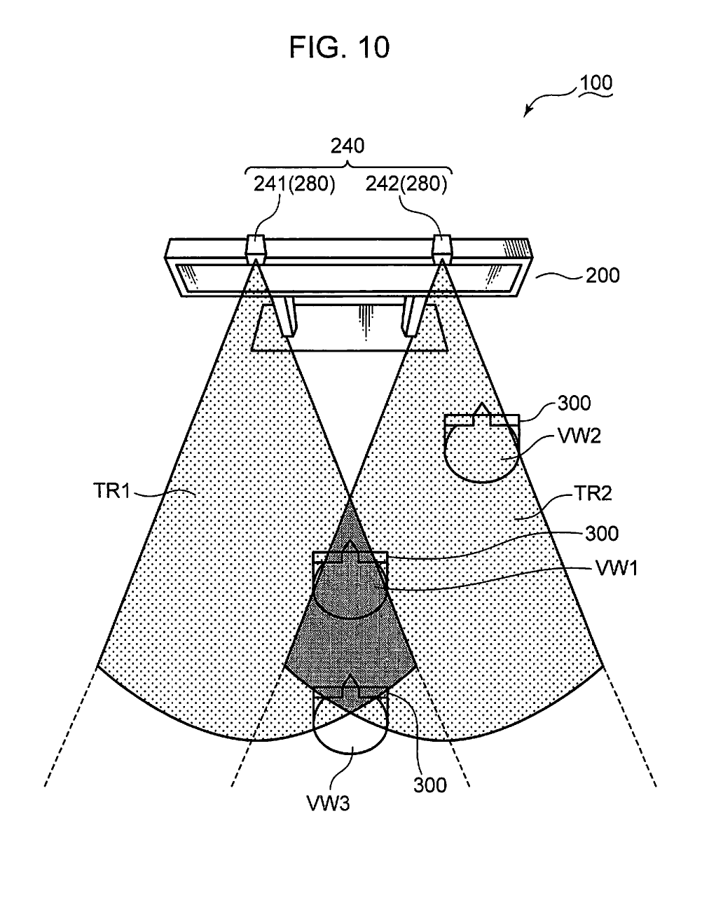

FIG. 10 is a perspective top view of the image viewing system 100 according to the present embodiment. The image viewing system 100 with the emission module 280 is described with FIGS. 2, 3, and 8 to 10.

The emission module 280 is used as the left transmitter 241 and the right transmitter 242 of the display device 200. The emission module 280, which is described in the context of FIG. 9, comprises more light emitters than the emission module 270 described in the context of FIG. 8. The emission module 280 with more light emitters enhances intensities of the transmitted synchronization signals to lengthen their transmission distance.

FIG. 10 shows the substantially fan-shaped transmitting range TR1 extending from the left transmitter 241 and the substantially fan-shaped transmitting range TR2 extending from the right transmitter 242. In comparison with FIGS. 2 and 10, it is figured out that the transmitting ranges TR1, TR2 shown in FIG. 10 are wider than the transmitting range TR shown in FIG. 2, in the horizontal direction and in the front direction.

The positions of the viewers VW1, VW2 and VW3 shown in FIG. 10 are the same as the positions shown in FIG. 2. The emission module 280 used as the left transmitter 241 and the right transmitter 242 covers all of the viewers VW1, VW2 and VW3 in the transmitting ranges TR1 and/or TR2. Consequently, the spectacle devices 300 of the viewers VEW1, VW2 and VW3 may appropriately receive the synchronization signals from the transmitter 240.

As described above, the emission module 280 used as the transmitter 240 may appropriately improve the narrow directional characteristics and the short transmission distance of the synchronization signals, as with the case of the emission module 270 described in the context of FIG. 8.

### Second Embodiment

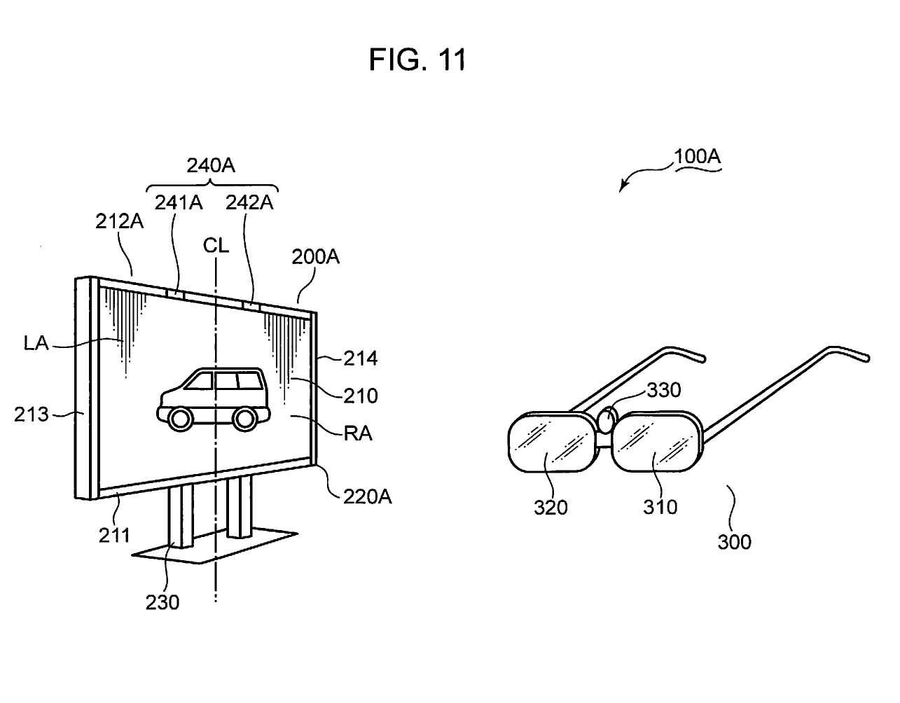

FIG. 11 is a schematic diagram showing an image viewing system according to a second embodiment. In FIG. 11, the components equivalent to those of the image viewing system 100 according to the first embodiment are denoted by the same reference numerals. The differences between the image viewing system according to the second embodiment and the image viewing system 100 according to the first embodiment are described with FIG. 11. The descriptions of the first embodiment are incorporated to describe features of the second embodiment which are the same as those of the first embodiment.

In addition to the spectacle device 300 which is the same as that of the first embodiment, an image viewing system 100A comprises a display device 200A configured to display stereoscopic images. A viewer may wear the spectacle device 300 to view the L image and the R image which are displayed and temporarily switched by the display device 200A, so that the viewer stereoscopically perceives the images displayed by the display device 200A.

In addition to the display portion 210 and base 230 which are the same as those of the first embodiment, the display device 200A comprises a frame 220A configured to surround the display portion 210 and a transmitter 240A configured to transmit the synchronization signals toward the spectacle device 300.

In addition to the lower frame portion 211, left frame portion 213 and right frame portion 214 which are the same as those of the first embodiment, the frame 220A includes an upper frame portion 212A extending along the upper edge of the display portion 210. The frame 220A may be used as a part of the housing for protecting and supporting the display portion 210.

FIG. 11 shows a centerline CL defined so as to evenly divide the display portion 210 into a left area LA and a right area RA. The transmitter 240A includes a left transmitter 241A disposed on the left side with respect to the centerline CL and a right transmitter 242A disposed on the right side with respect to the centerline CL. The right transmitter 242A is apart from the left transmitter 241A by a predetermined distance. It should be noted that the distance between the left transmitter 241A and the right transmitter 242A is appropriately defined according to characteristics of these transmitters (e.g., magnitudes or shapes of the transmitting range of the synchronization signals of the left transmitter 241A/right transmitter 242A). It is preferable that the left transmitter 241A and the right transmitter 242A are disposed substantially symmetrically with respect to the centerline CL. In the present embodiment, the left transmitter 241A is exemplified as one of the first transmitter and the second transmitter and the right transmitter 242A is exemplified as the other.

Unlike the first embodiment, the left transmitter 241A and the right transmitter 242A are buried in the upper frame portion 212A, so that the upper edge of the display device 200 becomes substantially flat, which results in the more aesthetic display device 200.

The synchronization signals are transmitted toward the spectacle device 300 from the left transmitter 241A and the right transmitter 242A which are buried in the upper frame portion 212A. The transmitter 240A transmits the synchronization signals in synchronization with the display of the stereoscopic images. For example, the transmitter 240A transmits the synchronization signals in accordance with the timing when the display of the L image and the R image starts. The display device 200A may generate and output the synchronization signals with any known methods. In the present embodiment the transmitter 240A transmits infrared signals as the synchronization signals. The transmitter may also transmit, as the synchronization signals, other types of signals to communicate with the spectacle device. In the present embodiment, the synchronization signals output from the transmitter 240A are used for performing the synchronous control between the display device 200A and the spectacle device 300. In addition, the synchronization signals output from the transmitter may be used for performing synchronous control between other devices than the spectacle device and the display device.

### Third Embodiment

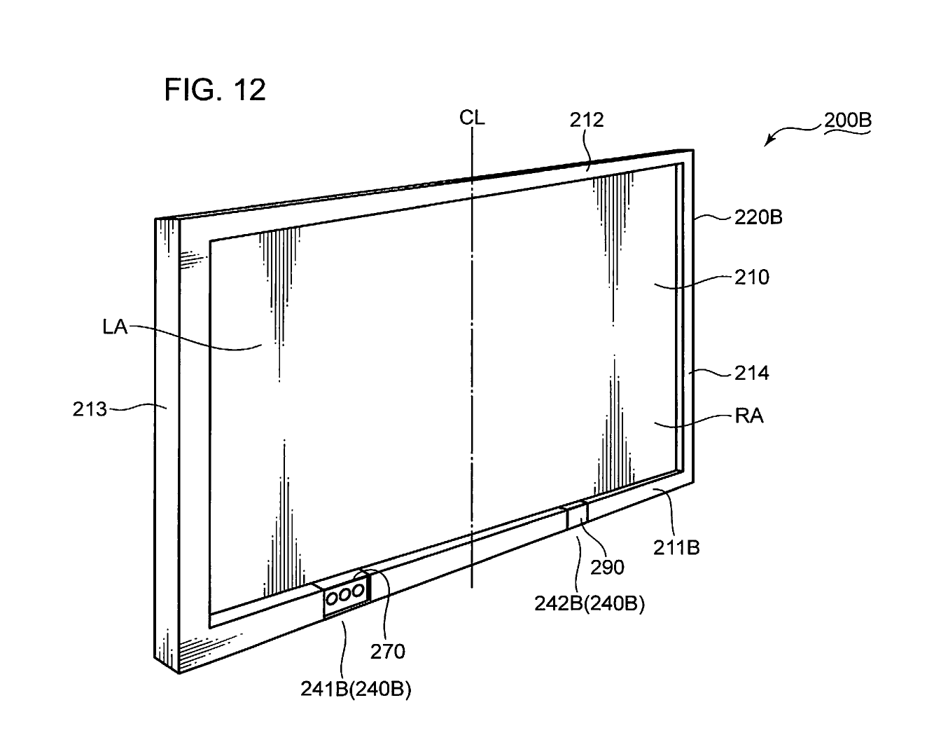

FIG. 12 is a schematic perspective view of a display device according to a third embodiment. The display device according to the third embodiment is described with FIG. 12. In FIG. 12, the components equivalent to those of the image viewing system 100 according to the first embodiment are denoted by the same reference numerals. The differences between the image viewing system according to the third embodiment and the image viewing system 100 according to the first embodiment are described with FIGS. 7, 9 and 12. The descriptions of the first embodiment are incorporated to describe features of the third embodiment which are the same as those of the first embodiment.

In addition to the display portion 210 which is the same as that of the first embodiment, a display device 200B according to the third embodiment comprises a frame 220B configured to surround the display portion 210, and a transmitter 240B configured to transmit the synchronization signals. In addition to the upper frame portion 212, left frame portion 213 and right frame portion 214 which are the same as those of the first embodiment, the frame 220B includes a lower frame portion 211B extending along the lower edge of the display portion 210. The frame 220B may be used as a part of the housing for protecting and supporting the display portion 210.

FIG. 12 shows a centerline CL defined so as to evenly divide the display portion 210 into a left area LA and a right area RA. The transmitter 240B includes a left transmitter 241B disposed on the left side with respect to the centerline CL and a right transmitter 242B disposed on the right side with respect to the centerline CL. The right transmitter 242B is apart from the left transmitter 241B by a predetermined distance. It should be noted that the distance between the left transmitter 241B and the right transmitter 242B is appropriately defined according to characteristics of these transmitters (e.g., magnitudes or shapes of the transmitting range of the synchronization signals of the left transmitter 241B/right transmitter 242B). It is preferred that the left transmitter 241B and the right transmitter 242B are disposed substantially symmetrically with respect to the centerline CL. In the present embodiment, the left transmitter 241B is exemplified as one of the first transmitter and the second transmitter while the right transmitter 242B is exemplified as the other one.

In the present embodiment, both the left transmitter 241B and the right transmitter 242B are buried in the lower frame portion 211B. The left transmitter 241B and the right transmitter 242B includes the emission modules 270 described in the context of FIG. 7 as well as covers 290 configured to cover the emission modules 270, respectively. The cover 290 hides the emission module 270 from the viewer. FIG. 12 does not show the cover 290 for the left transmitter 241B. Furthermore, the emission module 270 of the right transmitter 242B is covered with the cover 290 and thus is not shown in FIG. 12. In the present embodiment the emission module 270 is used as the left transmitter 241B and the right transmitter 242B. Alternatively, the emission module 280 described in the context of FIG. 9 may be used as the left transmitter 241B and the right transmitter 242B.

It is preferred that the cover 290 is the same color as or slightly different in hue from the lower frame portion 211B (the frame 220B). This allows the viewer to recognize the transmitter 240B as if the transmitter 240B is integrated with the frame 220B, which results in the more aesthetic display device 200B.

The cover 290 is formed of a material which allows a predetermined transmittance of the infrared rays emitted by the emission module 270 buried in the lower frame portion 211B. As a result, at least the light with the infrared wavelength is output to the outside of the display device 200B. The transmissive cover 290 to the infrared rays may be formed of any materials such acrylic resin or methacrylate resin. The cover 290 molded with the acrylic resin or the methacrylate resin becomes reflective of external light.

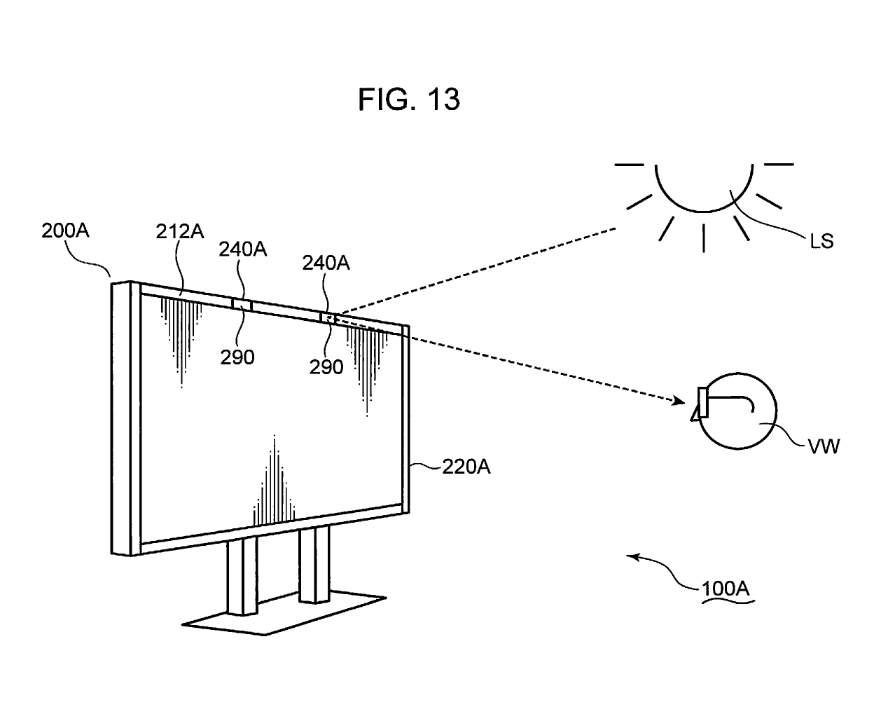

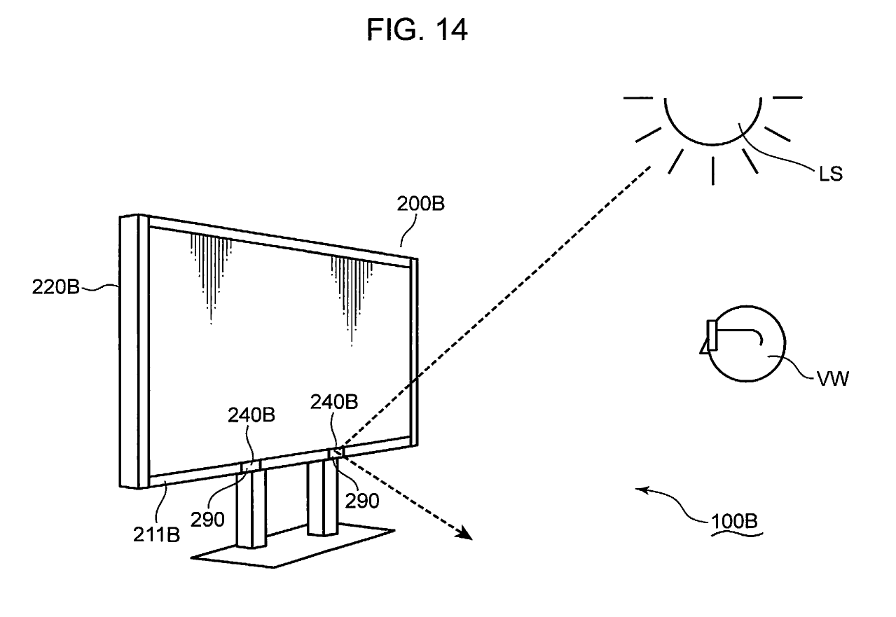

FIG. 13 is a schematic diagram showing the image viewing system 100A described in the context of the second embodiment. FIG. 14 is a schematic diagram showing the image viewing system 100B according to the third embodiment. It is described with FIGS. 13 and 14 how the position of the transmitters affects appearance of the display devices.

As described in the context of the second embodiment, the transmitter 240A of the display device 200A is buried in the upper frame portion 212A of the frame 220A. The transmitter 240A may have the cover 290, as with the transmitter 240B of the third embodiment.

Generally, a light source LS such as an indoor illumination is installed in an upper space than where the image viewing systems 100A, 100B are placed. Thus, some of the light emitted from the light source LS propagates to the transmitter 240A. The cover 290 of the transmitter 240A reflects the light emitted from the light source LS. A viewer VW perceives the reflected light from the cover 290.

Unlike the cover 290, the frames 220A, 220B do not have to be transmissive to the infrared rays. For this reason, the frames 220A, 220B are typically formed of different materials from the cover 290. As a result, it is more likely that the cover 290 has different reflectivity from the frames 220A, 220B.

As described in the context of FIG. 13, when the viewer VW perceives the reflected light from the cover 290, the viewer VW recognizes differences in reflectivity between the cover 290 and the upper frame portion 212A as a boundary between the transmitter 240A and the upper frame portion 212A. As a result, the viewer VW may feel the design of the display device 200A is different from what the viewer VW expects.

The problems in the context of the aforementioned reflection light arises from vertical arrangement among the light source LS, the transmitter 240A and the viewer VW in this order.

As described above, the transmitter 240B of the image viewing system 100B according to the third embodiment is attached to the lower frame portion 211B. Thus, the light source LS, the viewer VW and the transmitter 240B are arranged sequentially from top in the vertical direction. As a result, even when the cover 290 of the transmitter 240B reflects the light from the light source LS, it is less likely that the viewer VW perceives the reflected light.

When the viewer VW is less likely to perceive the reflected light as described above, the viewer hardly distinguish the lower frame portion 211B from the cover 290, so that it is less likely that the viewer perceives the transmitter 240B embedded in the lower frame portion 211B, which results in the more aesthetic display device 200B.

In the series of embodiments described above, the left transmitters 241, 241A, 241B and the right transmitters 242, 242A, 242B are disposed symmetrically with respect to the centerlines CL. As a result, the transmitting ranges become symmetric with respect to the centerlines CL, which enhances convenience for the viewers.

### Fourth Embodiment

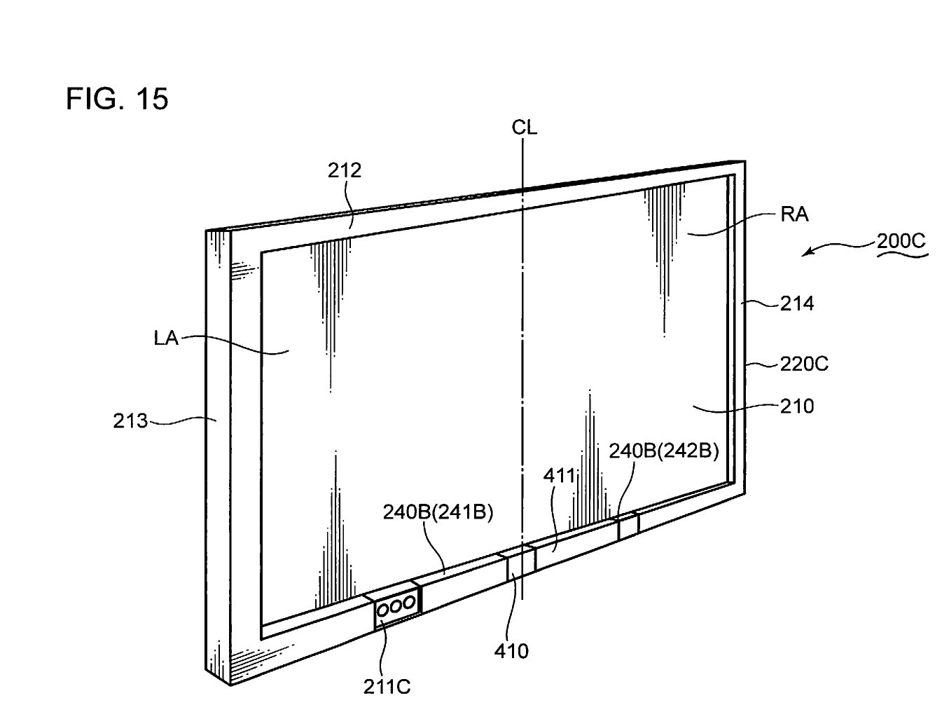

FIG. 15 is a schematic perspective view of a display device according to a fourth embodiment. The display device according to the fourth embodiment is described with FIG. 15. In FIG. 15, the components equivalent to those of the image viewing system 100B according to the third embodiment are denoted by the same reference numerals. The differences between the image viewing system according to the fourth embodiment and the image viewing system 100B according to the third embodiment are described with FIG. 15. The descriptions of the third embodiment are incorporated to describe features of the fourth embodiment which are the same as those of the third embodiment.

In addition to the display portion 210 and transmitter 240B which are the same as those of the third embodiment, a display device 200C according to the fourth embodiment comprises a frame 220C and a receiver 410 configured to receive external signals (e.g., control signals from a remote controller (not shown) for controlling the display device 200C).

The frame 220C includes a lower frame portion 211C extending along the lower edge of the display portion 210, in addition to the upper frame portion 212, left frame portion 213 and right frame portion 214 which are the same as those of the third embodiment. The frame 220C may be used as a part of the housing for protecting and supporting the display portion 210.

The receiver 410 receives the control signals (infrared rays) transmitted from, for example, the remote controller. The display device 200C performs any operations desired by the viewers (various operations including, for example, changing the channels or volumes), in response to control information included in the control signals. The receiver 410 includes a reception element (not shown) configured to receive the signals transmitted from the remote controller, and a cover 411 configured to cover the reception element. The cover 411 of the receiver 410 is formed of, for example, a transmissive material to the infrared rays, as with the cover of the transmitter 240B.

In terms of the reflected light described in the context of the third embodiment, the receiver 410 is preferably attached to the lower frame portion 211C of the frame 220C. More preferably, the receiver 410 is disposed between the left transmitter 241B and the right transmitter 242B.

FIG. 15 shows a centerline CL defined so as to evenly divide the display portion 210 into a left area LA and a right area RA. In the present embodiment the receiver 410 is disposed on the centerline CL. As a result, a receiving range in which the receiver 410 may receive the signals from the remote controller spreads out symmetrically with respect to the centerline CL, which results in more convenience for the viewers.

### Fifth Embodiment

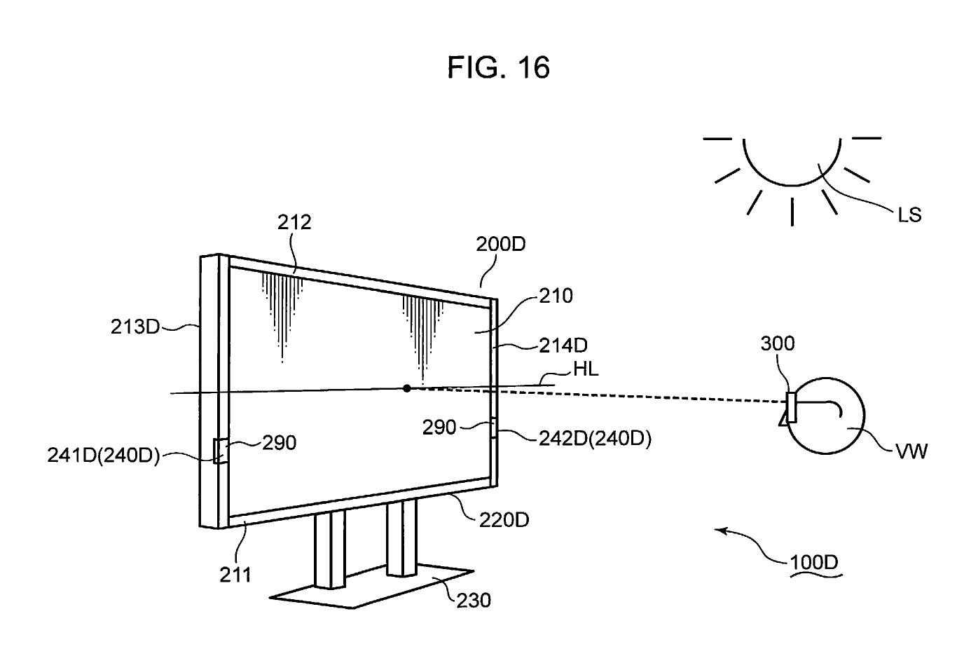

FIG. 16 is a schematic diagram showing an image viewing system according to a fifth embodiment. In FIG. 16, the components equivalent to those of the image viewing system 100B according to the third embodiment are denoted by the same reference numerals. The differences between the image viewing system according to the fifth embodiment and the image viewing system 100B according to the third embodiment are described with FIGS. 7, 9 and 16. The descriptions of the first embodiment and/or the third embodiment are incorporated to describe the same features of the fifth embodiment as those of the first embodiment and/or the third embodiment.

In addition to the spectacle device 300 which is the same as that of the first embodiment, an image viewing system 100D comprises a display device 200D configured to display stereoscopic images. A viewer may wear the spectacle device 300 to view the L image and the R image which are displayed and temporarily switched by the display device 200D, so that the viewer stereoscopically perceives the images displayed by the display device 200D.

In addition to the display portion 210 and the base 230 which are the same as those of the first embodiment, the display device 200D comprises a frame 220D configured to surround the display portion 210, and a transmitter 240D configured to transmit the synchronization signals toward the spectacle device 300.

In addition to the lower frame portion 211 and the upper frame portion 212 which are the same as those of the first embodiment, the frame 220D includes a left frame portion 213D extending along the left edge of the display portion 210, and a right frame portion 214D extending along the right edge of the display portion 210. The frame 220D may be used as a part of the housing for protecting and supporting the display portion 210.

The transmitter 240D includes a left transmitter 241D buried in the left frame portion 213D and a right transmitter 242D buried in the right frame portion 214D. As with the left transmitter 241B and the right transmitter 242B which are described in the context of the third embodiment, the left transmitter 241D and the right transmitter 242D comprise the emission module 270 described in the context of FIG. 7 (or the emission module 280 described in the context of FIG. 9), and the cover 290 configured to cover the emission module 270. It should be noted that the emission module 270 is covered with the cover 290 and thus is not shown in FIG. 16.

FIG. 16 shows a straight line HL which horizontally extends in a position corresponding to a level of the eyes of the viewer VW (an eye level assumed in the design). The transmitter 240D is preferably disposed below the straight line HL. As a result, the light source LS, the viewer VW and the transmitter 240D are arranged sequentially from top in the vertical direction.

In the series of embodiments described above, the display device comprises two transmitters (the left transmitters 241, 241A, 241B, 241D: the right transmitters 242, 242A, 242B, 242D). Alternatively, the display device may include two or more transmitters. The larger the number of transmitters installed in the display device, the wider the transmitting range of the synchronization signals.

In the series of embodiments described above, the transmitters 240, 240A, 240B and 240D output infrared rays as the synchronization signals. Alternatively, the transmitters may output invisible light beams other than the infrared rays, as the synchronization signals used in the image viewing systems.

The embodiments described above mainly include the following configurations.

A display device for displaying a stereoscopic image including a left-eye image viewed by a left eye and a right-eye image viewed by a right eye according to one aspect of the embodiments described above comprises: a display portion configured to display the left-eye image and the right-eye image; and a transmitter configured to transmit a synchronization signal synchronized with the stereoscopic image, wherein the transmitter includes a first transmitter and a second transmitter disposed away from the first transmitter.

According to the configuration mentioned above, the display portion displays the stereoscopic image including the left-eye image viewed by the left eye and the right eye-image viewed by the right eye. The transmitter transmits the synchronization signal synchronized with the stereoscopic image. Because of the transmitter including the first transmitter and the second transmitter disposed away from the first transmitter, the transmitting range of the synchronization signal becomes wider to deliver more reliable communication of the synchronization signal. As a result, the display device may suitably provide viewers with the stereoscopic image.

In the configuration mentioned above, it is preferred that one of the first transmitter and the second transmitter is disposed on a left side with respect to a centerline defined so as to divide the display portion into a left area and a right area, and that the other of the first transmitter and the second transmitter is disposed on a right side with respect to the centerline.

According to this configuration, one of the first transmitter and the second transmitter is disposed on the left side with respect to the centerline defined so as to divide the display portion into the left area and the right area, and the other of the first transmitter and the second transmitter is disposed on the right side with respect to the centerline. Therefore, the transmitting range of the synchronization signal becomes wider in the horizontal direction to deliver the more reliable communication of the synchronization signal. As a result, the display device may suitably provide the viewers with the stereoscopic image.

In the configuration described above, it is preferred that the first transmitter and the second transmitter are disposed symmetrically with respect to the centerline.

According to this configuration, because of the first and second transmitters disposed symmetrically with respect to the centerline, the transmitting range of the synchronization signal evenly spreads out in the horizontal direction from the centerline. Since it is less likely that the transmitting range of the synchronization signal becomes imbalanced in the horizontal direction, the transmitting range of the synchronization signal may encompass regions where the viewers comfortably view the stereoscopic image.

It is preferred that the display device described above further includes a frame configured to surround the display portion, and that the transmitter is attached to the frame.

According to this configuration, the transmitter is attached to the frame configured to surround the display portion, which results in the more aesthetic display device.

In the configuration described above, it is preferred that the frame include a lower frame portion extending along a lower edge of the display portion, and that the transmitter is attached to the lower frame portion.

According to this configuration, because of the transmitter attached to the lower frame portion extending along the lower edge of the display portion, it is less likely that the viewers perceive reflected light from the lower frame portion and the transmitter, which results in the more aesthetic display device.

In the configuration described above, it is preferred that the frame includes a left frame portion extending along a left edge of the display portion, and a right frame portion extending along a right edge of the display portion, that one of the first transmitter and the second transmitter is attached to the left frame portion, and that the other of the first transmitter and the second transmitter is attached to the right frame part.

According to this configuration, one of the first transmitter and the second transmitter is attached to the left frame portion extending along the left edge of the display portion, and the other of the transmitters is attached to the right frame portion extending along the right edge of the display portion, which results in a horizontally wider transmitting range.

In the configuration described above, it is preferred that the frame include an upper frame portion extending along an upper edge of the display portion, and that the transmitter is attached to the upper frame portion.

According to this configuration, because the transmitter is attached to the upper frame portion extending along the upper edge of the display portion, it is less likely that the synchronization signals from the transmitter is interfered with obstacles existing between any of the viewers and the display device, which results in more reliable communication of the synchronization signal. Consequently, the display device may suitably provide the viewers with the stereoscopic image.

In the configuration described above, it is preferred that at least one of the first transmitter and the second transmitter includes light emitters with different directional characteristics.

According to this configuration, at least one of the first transmitter and the second transmitter includes light emitters with different directional characteristics, so that the transmitting range of the synchronization signal is appropriately set.

It is preferred that the display device described above further includes a receiver configured to receive an external signal externally transmitted, and that the receiver is disposed between the first transmitter and the second transmitter.

According to this configuration, the receiver configured to receive the external signal externally transmitted is disposed between the first transmitter and the second transmitter. Arrangement among the first transmitter, the receiver and the second transmitter along the lower frame portion results in the more aesthetic display device.

An image viewing system according to another aspect of the embodiments described above includes: a display device configured to display a stereoscopic image including a left-eye image viewed by a left eye and a right-eye image viewed by a right eye, and a spectacle device configured to perform auxiliary operation to assist in viewing the stereoscopic image so as to allow the left eye to view the left-eye image and the right eye to view the right-eye image, wherein the display device includes a display portion configured to display the left-eye image and the right-eye image, and a transmitter configured to transmit a synchronization signal synchronized with the stereoscopic image, the spectacle device executes the auxiliary operation based on the synchronization signal, and the transmitter includes a first transmitter and a second transmitter disposed away from the first transmitter.

According to the configuration described above, the display portion displays the stereoscopic image including the left-eye image viewed by the left eye and the right eye-image viewed by the right eye. The transmitter transmits the synchronization signal synchronized with the stereoscopic image. The transmitter including the first transmitter and the second transmitter disposed away from the first transmitter widens the transmitting range of the synchronization signal. Therefore, the synchronization signal may be more reliably transmitted to the spectacle device. As a result, the spectacle device may stably perform the auxiliary operation based on the synchronization signal, so that the viewers may enjoy viewing the excellent stereoscopic image.

### INDUSTRIAL UTILITY

The principles of the embodiments described above are suitably utilized in a display device comprising a transmitter configured to transmit synchronization signals synchronized with the images to a spectacle device as well as in an image viewing system.

What is claimed is:

1. A display device for displaying a stereoscopic image including a left-eye image viewed by a left eye and a right-eye image viewed by a right eye comprising:
a display portion configured to display the left-eye image and the right-eye image; and
a transmitter configured to transmit a synchronization signal synchronized with the stereoscopic image,
wherein the transmitter includes a first transmitter and a second transmitter disposed away from the first transmitter.

2. The display device according to claim 1, wherein one of the first transmitter and the second transmitter is disposed on a left side with respect to a centerline defined so as to divide the display portion into a left area and a right area and the other of the first transmitter and the second transmitter is disposed on a right side with respect to the centerline.

3. The display device according to claim 2, wherein the first transmitter and the second transmitter are disposed symmetrically with respect to the centerline.

4. The display device according to claim 1, further comprising a frame configured to surround the display portion, wherein the transmitter is attached to the frame.

5. The display device according to claim 4, wherein the frame includes a lower frame portion extending along a lower edge of the display portion, and the transmitter is attached to the lower frame portion.

6. The display device according to claim 4, wherein the frame includes a left frame portion extending along a left edge of the display portion, and a right frame portion extending along a right edge of the display portion, one of the first transmitter and the second transmitter is attached to the left frame portion, and the other of the first transmitter and the second transmitter is attached to the right frame portion.

7. The display device according to claim 4, wherein the frame includes an upper frame portion extending along an upper edge of the display portion, and the transmitter is attached to the upper frame portion.

8. The display device according to claim 1, wherein at least one of the first transmitter and the second transmitter includes light emitters with different directional characteristics.

9. The display device according to claim 5, further comprising a receiver configured to receive an external signal externally transmitted,
wherein the receiver is disposed between the first transmitter and the second transmitter.

10. An image viewing system, comprising:
a display device configured to display a stereoscopic image including a left-eye image viewed by a left eye and a right-eye image viewed by a right eye; and
a spectacle device configured to perform auxiliary operation to assist in viewing the stereoscopic image so as to allow the left eye to view the left-eye image and the right eye to view the right-eye image,
wherein the display device includes a display portion configured to display the left-eye image and the right-eye image, and a transmitter configured to transmit a synchronization signal synchronized with the stereoscopic image,
the spectacle device executes the auxiliary operation based on the synchronization signal, and
the transmitter includes a first transmitter and a second transmitter disposed away from the first transmitter.
